(19) United States
(12) Patent Application Publication
(10) Pub. No.: US 2020/0156087 A1
(43) Pub. Date: May 21, 2020

(54) Multiple Nozzle System

(71) Applicant: Willis Dane, Peru, IL (US)

(72) Inventor: Willis Dane, Peru, IL (US)

(21) Appl. No.: 16/688,038

(22) Filed: Nov. 19, 2019

Related U.S. Application Data
(60) Provisional application No. 62/769,904, filed on Nov. 20, 2018.

(51) Int. Cl. B05B 1/14; B05B 17/08; B05B 1/10

(52) U.S. Cl. CPC B05B 1/14; B05B 1/10; B05B 17/08

(57) ABSTRACT

A multiple nozzle system and device that provides flow control, a nozzle base, the inclusion of a flare or a reversible flare, or a twister attachment, along with various desired directional arm(s) formed from nozzles or the combination of nozzles and elbows, for creating any desired directional angle(s) for each of the directional arm(s). Based on this invention, the water (or angled streams) exiting from the combination of the various directional arm(s) creates an unlimited number of possible resulting fountains or other visual water displays, spray patterns, or designs

### I. CROSS-REFERENCE TO RELATED APPLICATION

This patent application is a non-provisional application claiming priority from U.S. Provisional Patent Application Ser. No. 62/769,904, entitled Multiple Nozzle System, filed on Nov. 20, 2018, and is fully incorporated herein by reference.

### II. FIELD OF THE INVENTION

The present invention relates to a multiple nozzle system that is molded as multiple parts and used by assembling in various combinations with various components. The multiple nozzle system, in a non-limiting example, comprises nozzles, flow controls, nozzle base, flare, and various elbows that are arranged in a generally vertical orientation with each tilting slightly outwardly from the centerline, and with nozzles and flow controls attached to create a wide variety of possible spray patterns.

### III. DESCRIPTION OF THE PRIOR ART

Currently, there are several devices in the market that are designed to create multiple patterns. These devices are simplistic in that the user drills multiple holes in the device to create the nozzles and then plugs or blocks certain holes for the desired pattern. As a result, these types of devices are limited to just a few patterns. Also, the additional problems with this approach is that (a) it is very difficult to create good quality streams with this crude approach, and (b) the limitation in number of possible patterns automatically excludes all other patterns and thwarts further creative designs. Applicant's invention, however, solves these problems.

Thus, there is a need, therefore, and there has never been disclosed Applicant's invention.

### IV. SUMMARY OF THE INVENTION

The present invention is a multiple nozzle system and device that provides flow control, a nozzle base, the inclusion of a flare or a reversible flare, or a twister attachment, along with various desired directional arm(s) formed from nozzles or the combination of nozzles and elbows, for creating any desired directional angle(s) for each of the directional arm(s). Based on this invention, the water (or angled streams) exiting from the combination of the various directional arm(s) creates an unlimited number of possible resulting fountains or other visual water displays, spray patterns, or designs.

### V. BRIEF DESCRIPTION OF THE DRAWINGS

The Description of the Preferred Embodiment will be better understood with reference to the following figures:

FIG. 1 is a top perspective view of Applicant's multiple nozzle system device.

FIG. 2 is a cutaway top perspective view, with portions removed, of the multiple nozzle system device as illustrated in FIG. 1.

FIG. 3 is a side perspective view of the multiple nozzle system device and, in particular, illustrating the nozzle base, flare, elbows, and nozzles.

FIG. 4 is a top perspective view of the internal components of the multiple nozzle system device and, in particular, illustrating the channels in the nozzle base and attachment points and holes for mounting the nozzle(s), elbow(s), and twister attachment.

FIG. 5 is a top perspective view of the internal components of Section A of the multiple nozzle system device of FIG. 4.

FIG. 6 is a top perspective view of the internal components of Section B of the multiple nozzle system device of FIG. 4.

FIG. 7 is a side perspective view of the internal components of the multiple nozzle system device of FIG. 4.

FIG. 8 is a top view of the nozzle and, in particular, illustrating the nozzle hollow center.

FIG. 9 is a front perspective view of the nozzle and, in particular, illustrating the tapering of the nozzle from the nozzle inlet to the nozzle outlet.

FIG. 10 is a top perspective view of the elbow and, in particular, illustrating the elbow hollow center and elbow angle of the elbow as shown in FIG. 11.

FIG. 11 is a side perspective view of the elbow and, in particular, illustrating a first example of an elbow angle (e.g., a twenty-five degree elbow angle).

FIG. 12 is a top perspective view of the elbow and, in particular, illustrating the elbow hollow center and elbow angle of the elbow as shown in FIG. 13.

FIG. 13 is a side perspective view of the elbow and, in particular, illustrating a second example of an elbow angle (e.g., a ten degree elbow angle).

FIG. 14 is a left side perspective view of the nozzle as releaseably attaching or mating to stackable elbows and as also shown in FIGS. 15 and 16.

FIG. 15 is a front side perspective view of the nozzle as releaseably attaching or mating to stackable elbows as illustrated in FIG. 14 and, in particular, illustrating the resulting directional arm at the directional angle.

FIG. 16 is a right side cross-sectional view, taken along line 16-16 of FIG. 15, of the nozzle as releaseably attaching or mating to stackable elbows and, in particular, illustrating the resulting directional arm at the directional angle.

FIG. 17 is a front side cross-sectional view, taken along line 17-17 of FIG. 3, of the multiple nozzle system device and, in particular, illustrating each of the resulting directional angle(s) for each of the directional arm(s) and resulting flow or stream of water from the device.

FIG. 18 is a front perspective view of the flare or flare attachment to the nozzle base.

FIG. 19 is a front side cross-sectional view, taken along line 19-19 of FIG. 18, of the flare or flare attachment to the nozzle base.

FIG. 20 is a front perspective view of the reversible flare or reversible flare attachment to the nozzle base.

FIG. 21 is a front side cross-sectional view, taken along line 21-21 of FIG. 20, of the reversible flare or reversible flare attachment to the nozzle base.

FIG. 22 is a front perspective view of the twister or twister attachment to the nozzle base.

FIG. 23 is a front side cross-sectional view, taken along line 23-23 of FIG. 22, of the twister or twister attachment to the nozzle base.

FIG. 24 is a visual water display, fountain, spray pattern, and/or design and, in particular, illustrating a non-limiting example of a rotating or twisting lily design.

FIG. 25 is a visual water display, fountain, spray pattern, and/or design and, in particular, illustrating a non-limiting example of a super lily design.

FIG. 26 is a visual water display, fountain, spray pattern, and/or design and, in particular, illustrating a non-limiting example of a cluster arch design.

FIG. 27 is a visual water display, fountain, spray pattern, and/or design and, in particular, illustrating a non-limiting example of a lily design.

FIG. 28 is a visual water display, fountain, spray pattern, and/or design and, in particular, illustrating a non-limiting example of a high-flow tornado design.

FIG. 29 is a visual water display, fountain, spray pattern, and/or design and, in particular, illustrating a non-limiting example of a fan as part of a lily design.

### VI. DETAILED DESCRIPTION OF THE PREFERRED EMBODIMENT

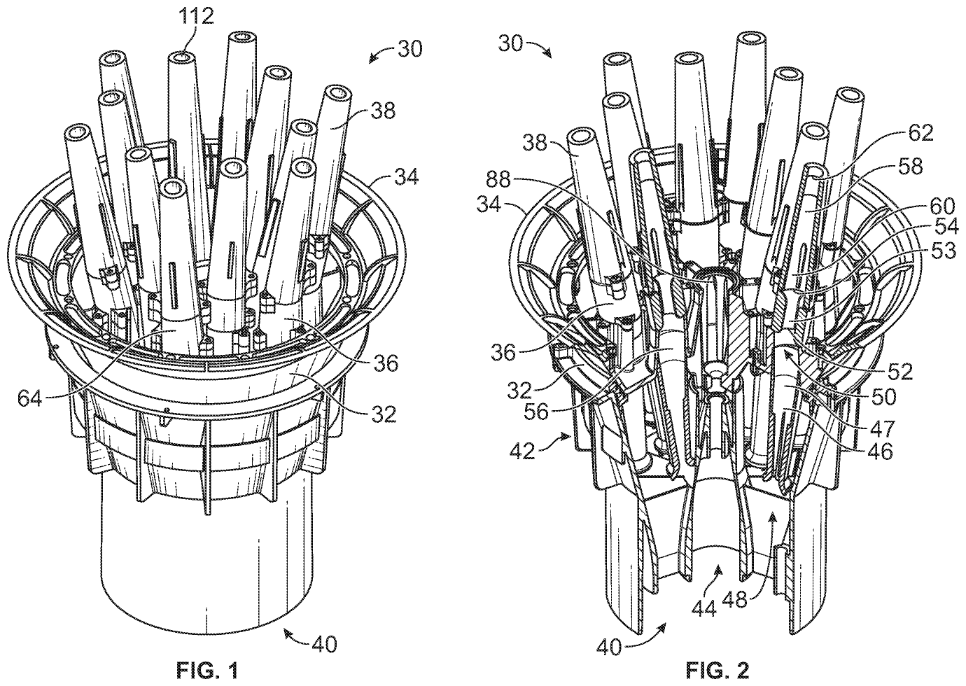

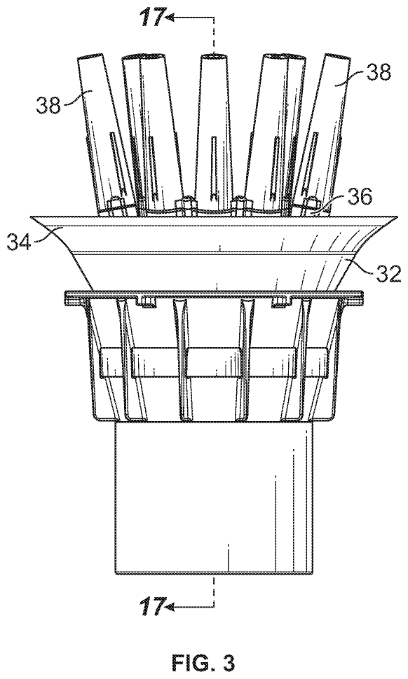

Applicant's multiple nozzle system is used in fountain or aeration devices for creating attractive water displays in a pond or lake. In use, water comes up from the bottom through Applicant's multiple nozzle system and the various nozzle designs and out the top. Depending upon the flow control, nozzle flare, elbow extensions and angles created, and nozzle tips and length, the water exits from the various nozzles, which in combination, creates a resulting fountain or other visual water displays, spray patterns, or designs. As a result and to accomplish this, as illustrated in FIGS. 1 and 2, Applicant's multiple nozzle system and device 30, provides many new and inventive elements including, without limitation, a nozzle base 32, a flare 34, elbows 36, and nozzles 38.

The nozzle base 32 is a hollow body 44 designed, at one end, with an inlet 40 and, at the other end, with an outlet 42. In this manner, the nozzle base 32 facilitates or allows for attachment, at the inlet 40, of a flow control device that controls and/or reduces pattern height for a resulting stream from the device 30 and the attachment, at the outlet 42, of elbows 36 and nozzles 38 that collectively control and/or create, using the resulting stream, any desired resulting visual water display, fountain, spray pattern, and/or design through the device 30. In the preferred embodiment, the visual water display, fountain, spray pattern, and/or design are comprised of water. Alternatively, the visual water display, fountain, spray pattern, and/or design may be comprised of any other substance as known to those skilled in the art.

Also, situated and extending within the hollow body 44 of the nozzle base 32 are channels 46. Each channel 46 has a channel hollow center 47, a channel inlet 48, and a channel outlet 50. The channels 46 are integrally molded within the nozzle base 32.

The elbow 36 likewise has an elbow hollow center 53, an elbow inlet 52, and an elbow outlet 54. In the preferred embodiment, the elbow inlet 52 of the elbow 36 is releaseably attached to the channel outlet 50 of the channel 46. In this manner, when connected, the elbow hollow center 53 of the elbow 36 and the channel hollow center 47 form a single hollow passageway 56.

The nozzle 38 also has a nozzle hollow center 58, a nozzle inlet 60, and a nozzle outlet 62. In the preferred embodiment, the nozzle inlet 60 of the nozzle 38 is releaseably attached to the elbow outlet 54 of the elbow 36. In this manner, when connected, the nozzle hollow center 58 of the nozzle 38 and the elbow hollow center 53 and the channel hollow center 47 collectively then form the single hollow passageway 56. Alternatively, the nozzle inlet 60 of the nozzle 38 could be releaseably attached directly to the channel outlet 50 of the channel 46 (i.e., eliminating the elbow 36, if desired). In this manner, when connected, the nozzle hollow center 58 of the nozzle 38 and the channel hollow center 47 would then collectively form the single hollow passageway 56.

In a non-limiting example, the device 30 is shown having twelve (12) nozzles 38. Alternatively, the number or plurality of nozzles 38 may be more or less, as desired, provided that the number of nozzles 38 used accomplishes the invention as described herein. In this manner, each of the nozzles 38 could be releasesably attached or connected to a corresponding elbow 36 or a corresponding channel 46, and then, for each elbow 36 used, the elbow 36 could then be releaseably attached or connected to a corresponding channel 46. Each individual combination of the nozzle 38, the elbow 36, and the channel 46, or combination of the nozzle 38 and the corresponding channel 46, collectively forms a directional arm 64. If, using the non-limiting example as illustrated in FIGS. 1 and 2, these individual combination(s) would then form a total of twelve (12) directional arms 64.

Also, to accomplish this mating and interaction of parts, the nozzle base 32, the channel 46, the elbows 36, and the nozzles 38 all have the same mating parts so they can be easily connected, interchanged, as needed or desired.

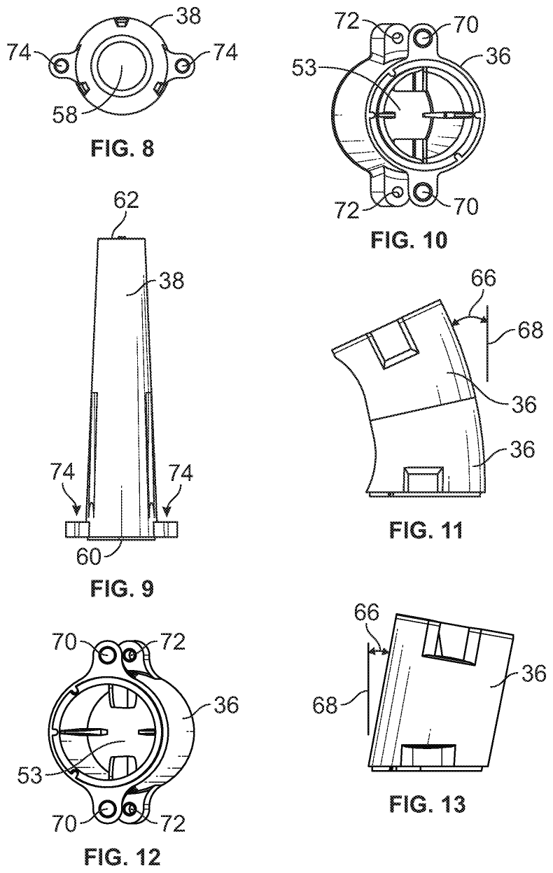

Turning to FIGS. 8 through 16, the various interconnections of the nozzles 38 to the elbows 36 and combination of resulting angles of the directional arms 64 are more clearly illustrated.

As illustrated in FIGS. 8 and 9, the nozzle 38 preferably tapers inwardly from the nozzle inlet 60 to the nozzle outlet 62. In a non-limiting example, the diameter of the nozzle hollow center 58 at the nozzle outlet 62 may be, for example, 0.5 inches or 0.6 inches. Alternatively, the diameter of the nozzle hollow center 58 may be larger or smaller as desired, provided that the nozzle holler center 58 accomplishes the invention as described herein.

The elbow 36 is designed to accommodate an angle 66, as measured from a vertical plane 68. In the non-limiting example, as illustrated in FIGS. 10 and 11, the angle 66 of the elbow 36 is substantially at twenty-five degrees (25°); as illustrated in FIGS. 12 and 13, the angle 66 of the elbow 36 is substantially at ten degrees (10°).

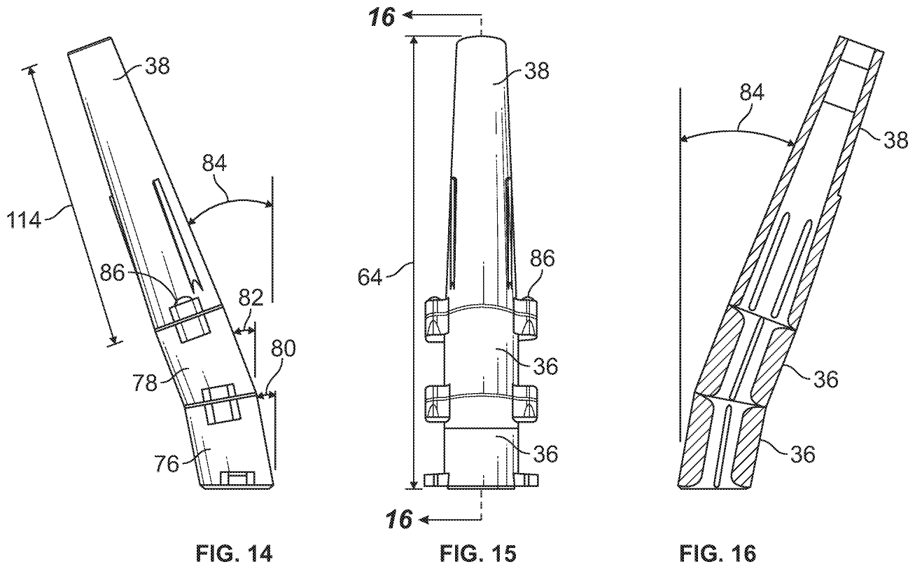

The elbow 36 is also provided with upper opposed holes 70 and lower opposed holes 72 (see FIGS. 10 and 12) and the nozzle 38 is likewise provided with opposed holes 74 (see FIG. 8). In the preferred embodiment, the releaseable attachment or mating of the nozzle 38 to the elbow 36 is accomplished by aligning the opposed holes 74 of the nozzle 38 with the upper opposed holes 70 of the elbow 36. In this manner, mechanical fasteners 86, such as threaded screws or bolts can be inserted through each of the opposed holes 74 and upper opposed holes 70 to secure the nozzle 38 to the elbow 36, as illustrated in FIGS. 14 through 16. Alternatively, any other means for securing the opposed holes 74 of the nozzle 38 to upper opposed holes 70 of the elbow 36 to releaseably secure one another together.

Preferably, the elbow 36, by itself, or stacked in combination with another elbow 36, can create or form the desired angle of the directional arms 64. For example, and as illustrated in FIGS. 14 through 16, a first elbow 76 is illustrated as having a first angle 80. A second elbow 78, stacked on top of the first elbow 80, is illustrated as having a second angle 82. If, in a non-limiting example, the first angle 80 of the first elbow 76 is ten degrees (10°) and the second angle 82 of the second elbow 78 is likewise ten degrees (10°) and both of the first elbow 76 and the second elbow 78 are releaseably attached or secured to the nozzle 38, this would result in a total directional angle 84 of the directional arm 64 to be twenty degrees (20°) (e.g., which is the combined total of both the first angle 80 and the second angle 82).

Alternatively, if the first angle 80 of the first elbow 76 is ten degrees (10°) and only this first elbow 76, individually, is releaseably attached or secured to the nozzle 38, this would result in a total directional angle 84 of the directional arm 64 to be ten degrees)(10° (e.g., which is the total of just the first angle 80).

In another non-limiting alternative, if the first angle 80 of the first elbow 76 is twenty-five degrees (25°) (i.e., using the angle 66 of the elbow 36 as illustrated in FIGS. 10 and 11), only this first elbow 76, individually, is releaseably attached or secured to the nozzle 38, this would result in a total directional angle 84 of the directional arm 64 to be twenty-five degrees (25°) (e.g., which again is the total of just the first angle 80 but using a first elbow 76 having a different first angle 80).

Likewise, the combination and angles of the elbows can be reversed to achieve an increase (i.e., albeit smaller increase), as desired. In another non-limiting alternative example, if the first angle 80 of the first elbow 76 is twenty-five degrees (25°) and the second angle 82 of the second elbow 78 is a reversed ten degrees (10°) (i.e., the second elbow 78 is releaseably attached or secured to the first elbow 76 in a reversed orientation), this would result in the total directional angle 84 of the directional arm 64 to be fifteen degrees (15°) (e.g., which is the combined total of both the first angle 80 of twenty-five degrees (25°) minus the second angle 82 of ten degrees (10°) resulting in the total directional angle 84 of fifteen degrees (15°).

In this manner, multiple elbows can be stacked one on top of another to increase the directional angle 84 of the directional arm 64 to create or form streams emanating from the device 30 in a preferred range of substantially five degrees (5°) up to sixty degrees (60°) to the vertical in any of the desired nozzles 38. Alternatively, the range of the directional angle 84 may be higher or lower depending upon the spray pattern desired.

Additionally, based on the various combination(s), Applicant's device 30 allows any of the nozzles 38 and/or directional arms 64 to be designed to accommodate any angle in five degree (5°) increments such as (5°, 10°, 15°, 20°, 25°, etc.) where the five degree (5°) angle is created by using the combination of a first angle 80 of the first elbow 76 to be twenty-five degree (25°) and the second angle 82 of the second elbow 78 in a ten degree (10°) angle reversed orientation to the first elbow 76 along with a third angle of a third elbow in likewise another ten degree (10°) angle reversed orientation to the first elbow 76 (e.g., which is the combined total of the first angle 80 of twenty-five degrees (25°) minus the second angle 82 of ten degrees (10°) minus the third angle of ten degrees (10°) resulting in the total directional angle 84 of five degrees (5°).

Thus, in the present non-limiting example of twelve (12) nozzles 38, as illustrated in FIGS. 1 and 2, or any number of nozzles 38 desired by the user, each nozzle 38 could have none or one or more elbows 36 attached or stacked in combination with each nozzle 38 to create the same or any different directional angles 84, as desired by the user, for each of the twelve (12) nozzles, or any number of nozzles 38 desired by the user, and/or required or used in producing the desired fountain or other visual water displays, spray patterns, and/or designs.

And, the nozzle base 32 and all of the various elbow(s) 36 and/or nozzle(s) 38 are designed to accommodate high volumes of water to flow through these well engineered parts, thus, producing heavy, clean, and attractive streams—this is likewise another capability not achieved by other prior art devices.

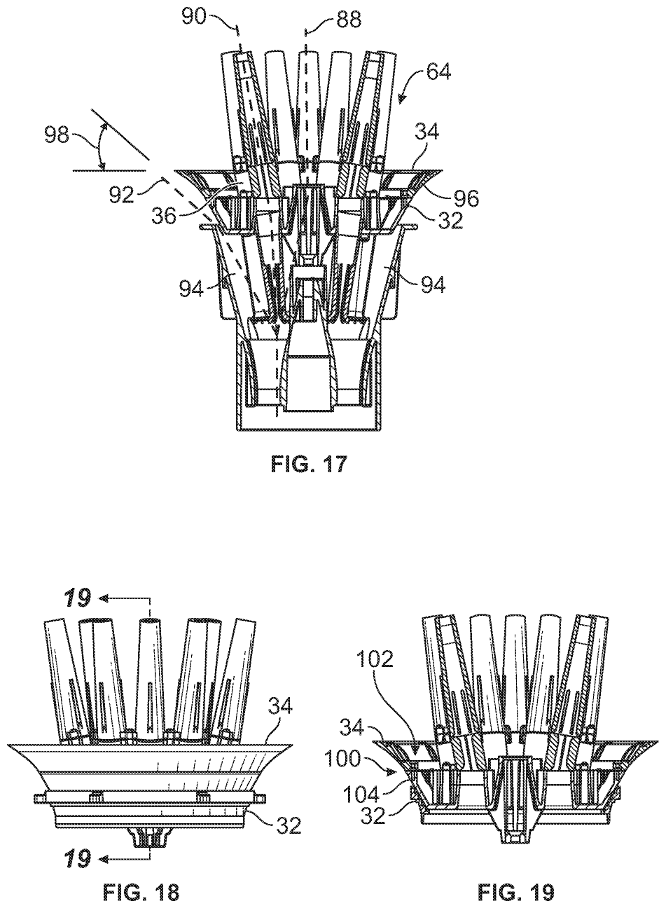

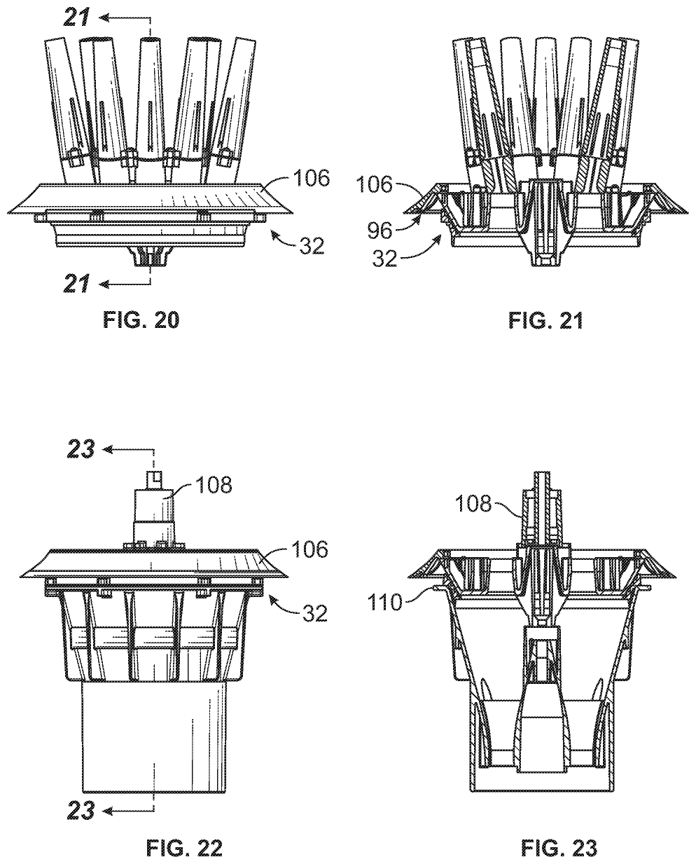

Turning to FIG. 17, upon the creation of each directional arm 64 resulting from any combination or not of the elbow 36 or elbow(s) 36 and resulting directional angle(s) 84 for each of the directional arm(s) 64, the resulting flow or stream of water from the device 30 is more clearly illustrated. A center vertical stream 88 is produced along with a plurality of other various angled streams 90 from each of the other directional arm(s) 64.

In the preferred embodiment, there is also a flare stream 92 produced from the flare 34. This is preferably produced by the flare stream 92 flowing up through the nozzle base 32 and into an outflow transition 94 (see FIG. 17). When the flare stream 92 exits out of the outflow transition 94, the flare stream 92 is directed along the outer surface 96 of the flare 34 having a flare angle 98 as measured in relation to the horizontal plane. In this manner, the flare stream 92 is used to create a flare pattern which is a fan of water at a low angle (i.e., the flare angle 98) to the surface of the water surface (e.g., such as a pond or lake, etc.).

The flare 34 is releasably attached or connected to the nozzle base 32 using a fastening means 100. Preferably, the fastening means comprises threaded screws or bolts 102 inserted through correspondingly aligned receiving holes 104 to thereby secure the flare 34 to the nozzle base 32, as illustrated in FIG. 19. Alternatively, any other fastening means 100 known to one skilled in the art may be used to releaseably secure these parts together.

Additionally, a reversible flare 106 can be attached to the nozzle base 32. In the preferred embodiment, the reversible flare 106 is the exact same as the flare 34 except flipped or upside down. In this manner, the flare stream 92 flowing up through the nozzle base 32 and into and exiting out of the outflow transition 94 (see FIG. 17) will likewise be directed at the outer surface 96 of the reversible flare 106. With the reversible flare 106 being flipped or upside down, the reversible flare 106 is used as a spray shield to deflect unwanted leakage or certain patterns so that the leakage falls straight down back to the surface of the water surface (e.g., such as a pond or lake, etc.) and is not seen in the resulting fountain or other visual water displays, spray patterns, and/or designs being produced.

As illustrated in FIGS. 22 and 23, in lieu of a nozzle 38 being placed directly in the center where the center vertical stream 88 exits (see FIGS. 2 and 17), a twister attachment 108 could be connected to the nozzle base 32 at this location. In the preferred embodiment, the twister attachment 108 allows the nozzle base 32 to self rotate by attaching some or all of the surrounding nozzles 38 at a slight angle, thus producing a tangential force that causes rotation of the nozzle base 32.

In addition, it is also preferable for the twister attachment 108 to be used in conjunction with a labyrinth seal 110, which allows virtually any of the numerous possible patterns to rotate. Rotation is accomplished because the nozzle base 32 is designed to optionally attach a plurality of nozzles 38 at an angle that creates a sideways torque that produces rotation. Further, the rate of spin can be controlled by the number of nozzles 38 attached at this angle.

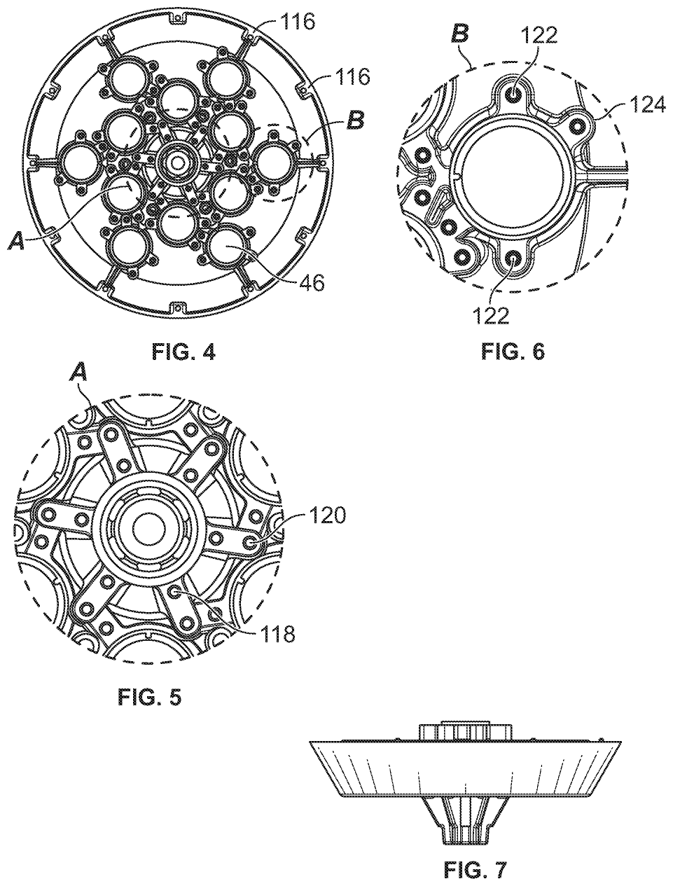

Internally, as illustrated in FIG. 4, depicts the interconnection of the nozzle(s) 38 or elbow(s) 36 to the nozzle base 32. The flare 34 or reversible flare 106 are releasably attached or connected to the nozzle base 32 using at flare attachment points 116 using the fastening means 100, as described above. Specifically shown in FIG. 4 are various attachment sections, Section A, more clearly illustrated in FIG. 5, and Section B, more clearly illustrated in FIG. 6.

In Section A, as illustrated in FIG. 5, nozzle mounting holes 188 are used to releaseably attach the nozzle(s) 38; and twister attachment mounting holes 120 are used to releaseably attached the twister attachment 108.

In Section B, as illustrated in FIG. 6, additional default nozzle/elbow mounting holes 122 are used to releaseably attach the nozzle(s) 38 or elbow(s) 36; and specific nozzle/elbow mounting holes 124 are used to attach certain nozzle(s) 38 or elbow(s) 36 at certain desired angles, such as, for example, forty-five degrees (45°).

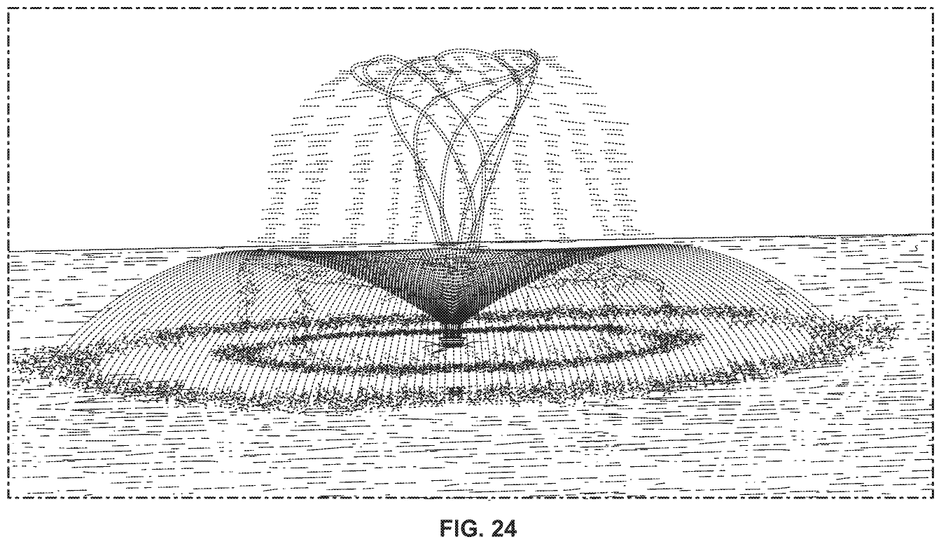

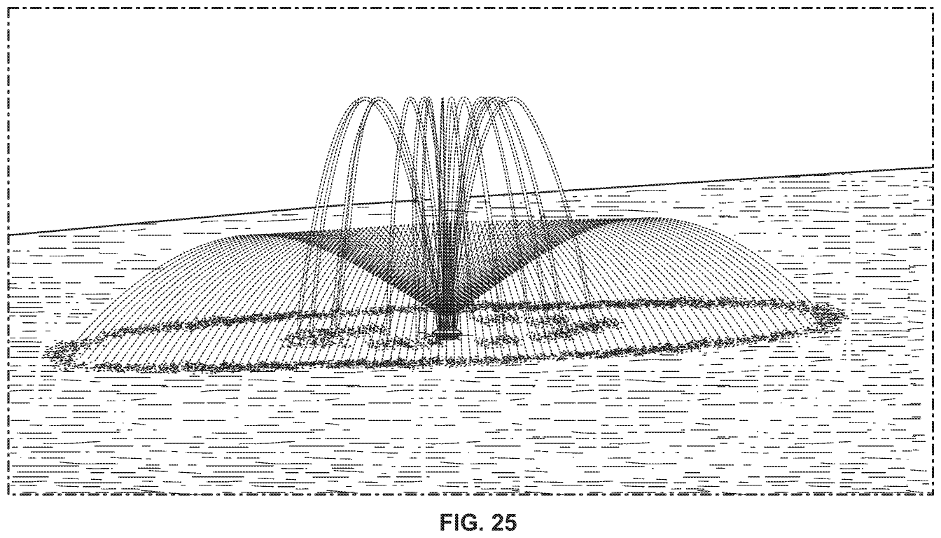

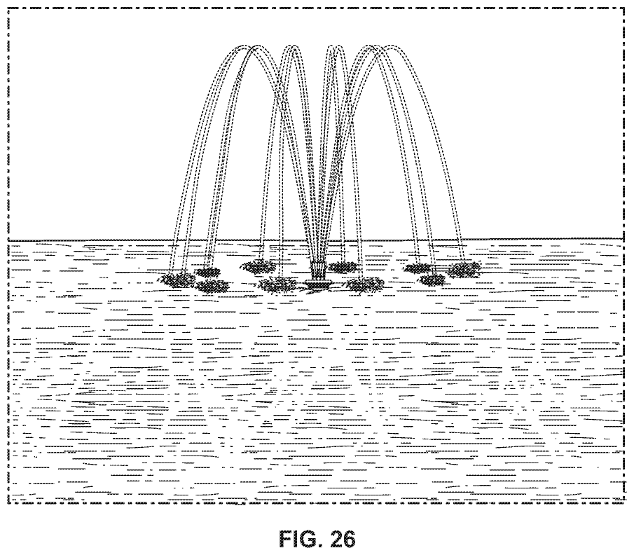

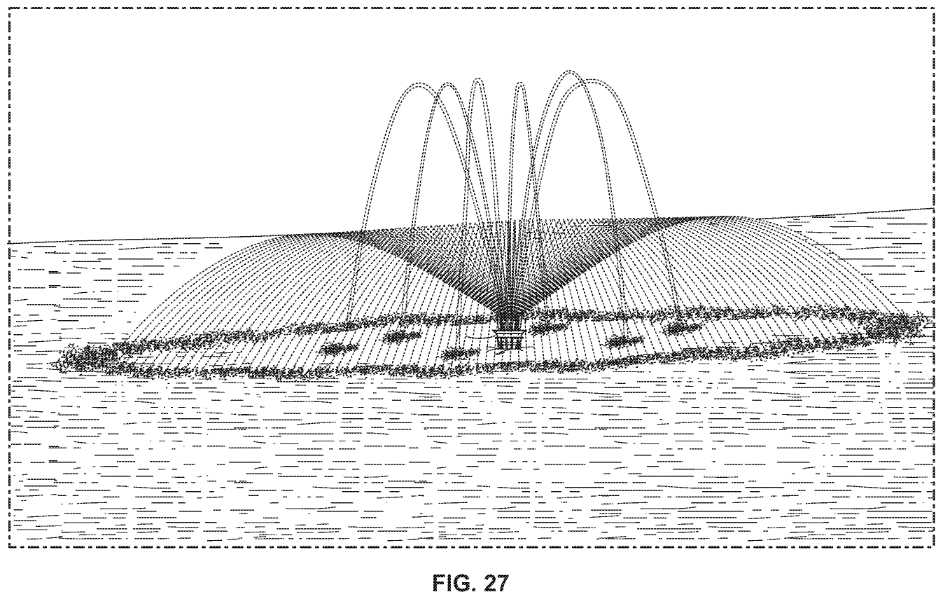

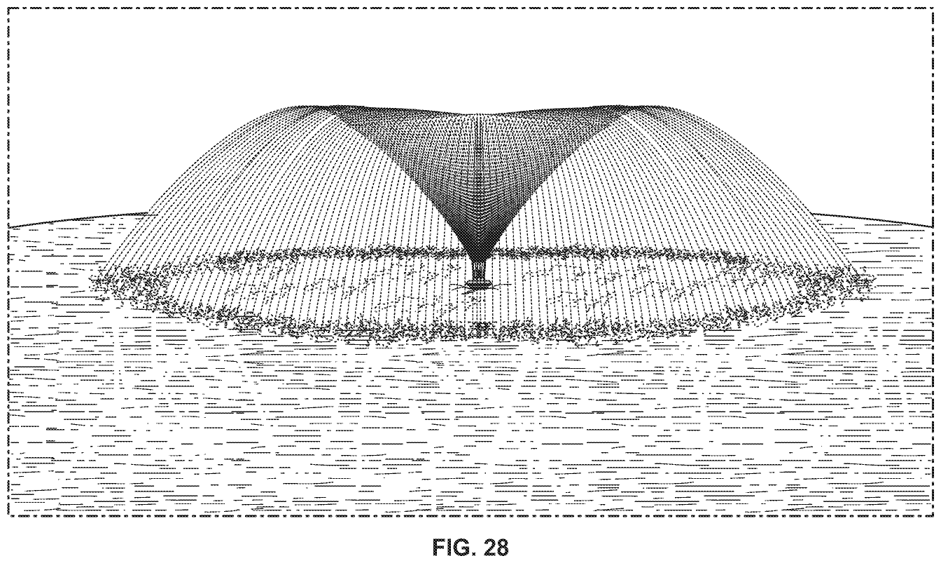

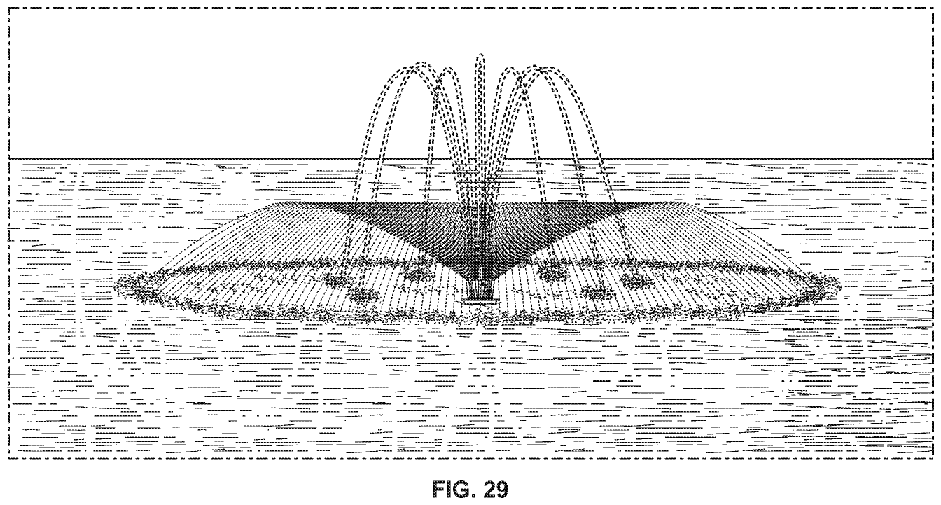

Depending upon the flow control, the nozzle base 32, whether the flare 34 or reversible flare 106 is used, whether the twister attachment 108 is used, each of the desired directional arm(s) 64 from the combination of the nozzles 38 and elbows 36 used, and the resulting directional angle(s) 84 created for each of the directional arm(s) 64, and possibly the nozzle tips 112 (see FIG. 1) and nozzle length 114 (see FIG. 14), the water (or angled streams 90 (see FIG. 17) exiting from the combination of the various directional arm(s) 64 creates an unlimited number of possible resulting fountains or other visual water displays, spray patterns, or designs (collectively referred to herein as “designs”). Various non-limiting design examples are illustrated in FIG. 24 (rotating or twisting lily design), FIG. 25 (super lily design), FIG. 26 (cluster arch design), FIG. 27 (lily design), FIG. 28 (high-flow tornado design), and FIG. 29 (fan as part of a lily design). Without limitation, for example, any of these designs could also have near vertical or any angled streams that no other multi nozzle system can accomplish.

Based on the description of the device 30 above, Applicant's multiple nozzle system also provides additional benefits and advantages which include without limitation:

(i) Allows for up to at least forty (40) standard nozzle configurations to be designed or built within Applicant's inventive multiple nozzle system using the same or one set of parts, and these parts create thick, high quality, attractive and coherent streams.

(ii) Applicant's inventive multiple nozzle system and component parts can be prebuilt in-house;

(iii) Applicant's component parts can be built or rebuilt by the customer and assembly and dis-assembly of the multiple nozzle system requires only a screwdriver;

(iv) Allows customer the flexibility to change and/or create new patterns, at any time, to whatever pattern they desire or feel like;

(v) And, with Applicant's multiple nozzle system being an additive system (components are added as required to make any specific pattern), the user can create many more possible patterns because Applicant's nozzles, elbows, nozzle tips, and flow controls can be attached in many different ways and are not limited to the initial set of drilled holes; and

(vi) Further, in Applicant's system, the flow control component(s) can be releaseably attached to any nozzle to efficiently reduce the height of the stream so that multi-tiered patterns can be produced—which is something that the other systems cannot do.

Thus, there has been provided Applicant's unique inventive multiple nozzle system. While the invention has been described in conjunction with a specific embodiment, it is evident that many alternatives, modifications and variations will be apparent to those skilled in the art in light of the foregoing description. Accordingly, it is intended to embrace all such alternatives, modifications and variations as fall within the spirit and scope of the appended claims.

What is claimed is:

1. A device for use with a fluid comprising:
a nozzle base defining an inlet at one end and an outlet at the other end;
a plurality of channels situated within the nozzle base between the inlet and the outlet, the plurality of channels comprising a first selected set of channels and a second selected set of channels;
a first plurality of nozzles releaseably attached to the first selected set of channels;
the first plurality of nozzles defining a first set of directional arms with each of the directional arms situated at a first plurality of directional angles;
a plurality of elbows releaseably attached to the second selected set of channels;
a second plurality of nozzles releaseably attached to the plurality of elbows;
the combination of the plurality of elbows and the second plurality of nozzles defining a second set of directional arms with each of the second set of directional arms situated at a second plurality of directional angles;
wherein the flow of fluid through the channels and into and out of the first set of directional arms at the first plurality of directional angles and the second set of directional arms at the second plurality of directional angles creates a visual fluid display.

2. The device of claim 1 wherein each of the plurality of channels comprises a hollow center and defining a channel inlet and a channel outlet at opposed ends.

3. The device of claim 2 wherein each of the first plurality of nozzles comprises a first nozzle hollow center and defining a first nozzle inlet and a first nozzle outlet at opposed ends.

4. The device of claim 3 wherein each of the plurality of elbows comprises an elbow hollow center and defining an elbow inlet and an elbow out at opposed ends.

5. The device of claim 4 wherein each of the second plurality of nozzles comprises a second nozzle hollow center and defining a second nozzle inlet and a second nozzle outlet at opposed ends.

6. The device of claim 5 wherein the first nozzle hollow center in each of the first plurality of nozzles is aligned with a corresponding hollow center in each of the first selected set of channels in the first set of directional arms.

7. The device of claim 6 wherein the elbow hollow center in each of the plurality of elbows is aligned with a corresponding hollow center in each of the second selected set of channels in the second set of directional arms.

8. The device of claim 7 wherein the second nozzle hollow center in each of the second plurality of nozzles is aligned with a corresponding elbow hollow center in each of the plurality of elbows in the second set of directional arms.

9. The device of claim 1 wherein at least more than one of the first plurality of directional angles are at different angles.

10. The device of claim 9 wherein at least more than one of the second plurality of directional angles are at different angles.

11. The device of claim 10 wherein at least more than one of the first plurality of directional angles are at different angles than the second plurality of directional angles.

12. The device of claim 1 wherein, if any one of the first plurality of directional angles is desired to be changed, an elbow is inserted between one of the first plurality of nozzles and one of the first selected set of channels.

13. The device of claim 1 wherein, if any one of the second plurality of directional angles is desired to be changed, one of the plurality of elbows is replaced with a different elbow.

14. The device of claim 13 wherein, if any one of the second plurality of directional angles is desired to be changed, a first additional elbow is inserted between one of the second plurality of nozzles and one of the second selected set of channels.

15. The device of claim 14 wherein a second additional elbow may be inserted and stacked with the first additional elbow between one of the second plurality of nozzles and one of the second selected set of channels.

16. The device of claim 15 wherein each of the plurality of elbows, the elbow, and the first additional elbow, and the second additional elbow are set at a specific elbow angle.

17. The device of claim 16 wherein at least more than one of the specific elbow angle of the each of the plurality of elbows, the elbow, the first additional elbow, and the second additional elbow are at different angles.
